(19) United States
(12) Patent Application Publication
(10) Pub. No.: US 2007/0075302 A1
(43) Pub. Date: Apr. 5, 2007

(54) Modular winch drum guard

(75) Inventors: Daniel S. Munko, Snohomish, WA (US); Paul M. Codd, Seattle, WA (US)

Correspondence Address: MICHAEL BEST & FRIEDRICH, LLP, 100 E WISCONSIN AVENUE, Suite 3300, MILWAUKEE, WI, 53202, US

(73) Assignee: Ingersoll-Rand Company, Montvale, NJ (US)

(21) Appl. No.: 11/231,627

(22) Filed: Sep. 21, 2005

(51) Int. Cl. B66D 1/00; B66D 3/00

(52) U.S. Cl. 254/333; 254/383

(57) ABSTRACT

In one embodiment, the invention provides a winch including a frame and a drum rotatably supported by the frame having an exposed portion not covered by the frame. A prime mover is adapted to rotate the drum and a flexible tension member is adapted to be wound about the drum as it rotates. As it rotates, the flexible tension member defines a takeoff angle with respect to the drum. A drum guard is supported by the frame, covering substantially the entire exposed portion of the drum, and includes a plurality of guard panels, wherein at least one of the guard panels is removable to define a window through which the flexible tension member extends for substantially any takeoff angle.

### BACKGROUND

The present invention relates to a guard assembly for a winch drum.

### SUMMARY

In one embodiment, the invention provides a winch including a frame and a drum rotatably supported by the frame and having an exposed portion not covered by the frame. The winch also includes a flexible tension member interconnected with the drum and wound onto and off of the drum in response to drum rotation in respective winding and unwinding directions. The flexible tension member defines a takeoff angle with respect to the drum. The winch also includes a drum guard including a plurality of guard panels supported by the frame to cover substantially the entire exposed portion of the drum except for a window defined between two panels and corresponding to the takeoff angle of the flexible tension member, wherein the guard panels are movable to move the window to accommodate substantially any takeoff angle within the exposed portion.

In another embodiment, the invention provides a drum guard for a winch drum having an exposed portion, the drum guard including a frame adapted to be mounted adjacent opposite ends of the winch drum, a plurality of support rods adapted to be mounted to the frame and extend across the exposed portion of the winch drum, and a plurality of guard panels supported by two support rods to cover the exposed portion.

In yet another embodiment, the invention provides a method of covering a winch drum and accommodating a flexible tension member extending from an exposed portion of the winch drum at a takeoff angle, the method including extending a plurality of support rods across the exposed portion of the winch drum and supporting a plurality of guard panels with the support rods. The method also includes defining a window between two guard panels through which the flexible tension member extends and substantially entirely covering the exposed portion of the winch drum with the guard panels except for the window.

Other aspects of the invention will become apparent by consideration of the detailed description and accompanying drawings.

### BRIEF DESCRIPTION OF THE DRAWINGS

FIG. 1 is a perspective view of a winch with an automatic band brake.

FIG. 2 is a cross-sectional view taken along line 2-2 in FIG. 1.

FIG. 3 is an exploded view of a winch guard assembly for the winch of FIG. 1.

FIG. 4 is a front perspective view of the winch of FIG. 1 with the guard assembly mounted thereon.

FIG. 5 is a rear perspective view of the winch of FIG. 1 with the guard assembly mounted thereon.

FIG. 6 is a perspective view of a winch similar to that illustrated in FIG. 1, except having a manually-operated band brake.

FIG. 7 is an exploded view of a winch guard assembly for the winch of FIG. 6.

FIG. 8 is a front perspective view of the winch of FIG. 6 with the guard assembly mounted thereon.

FIG. 9 is a rear perspective view of the winch of FIG. 6 with the guard assembly and a cable guide assembly mounted thereon.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

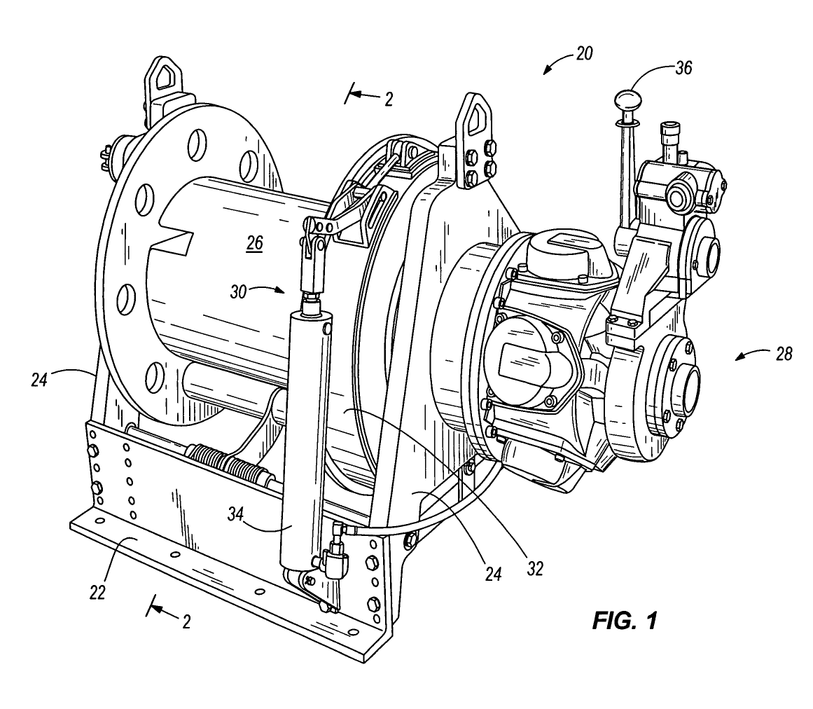

FIG. 1 illustrates a winch 20 including a frame 22 including drum supports 24, a drum 26 supported for rotation about its axis of rotation by the drum supports 24, a prime mover 28 rigidly supported by the frame 22, and an automatic band brake 30. The illustrated prime mover 28 operates under the influence of compressed air. In other embodiments and constructions, the prime mover 28 may be of a type that operates under the influence of electricity, internal combustion, or another motive force. The prime mover 28 also includes a transmission that permits it to rotate the drum 26 clockwise and counterclockwise. The automatic band brake 30 comprises a two-piece band 32 extending around one end of the drum 26, and an actuation cylinder 34 that tightens the band 32 to resist rotation of the drum 26. The automatic band brake 30 is redundant of internal disk brakes (not shown) within the winch 20, and is referenced to a throttle 36 of the prime mover 28 to engage the drum 26 when the throttle is closed and disengage the drum 26 when the throttle is open. The throttle 36 is deemed “open” when the prime mover 28 is operating and “closed” when the prime mover 28 is not operating.

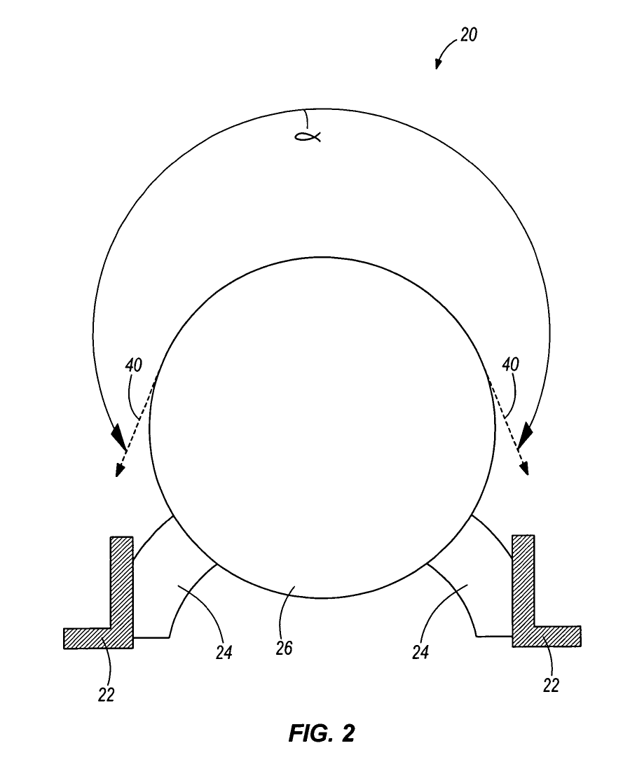

With reference to FIG. 2, a flexible tension member 40 is characterized by a takeoff angle α, which is arbitrarily said to be 0° for the takeoff angle α illustrated in solid lines. The illustrated winch 20 permits takeoff angles ranging from 0° to about 270° (corresponding to the takeoff angle α illustrated in phantom), but this will vary for other winch 20 constructions. The flexible tension member 40 is wound onto and off of the drum 26 in response to the drum 26 rotating in respective winding and unwinding directions under the influence of the prime mover 28. The flexible tension member 40 may be, for example and without limitation, rope, wire rope, cable, chain, or any other flexible tension member suitable for a particular application.

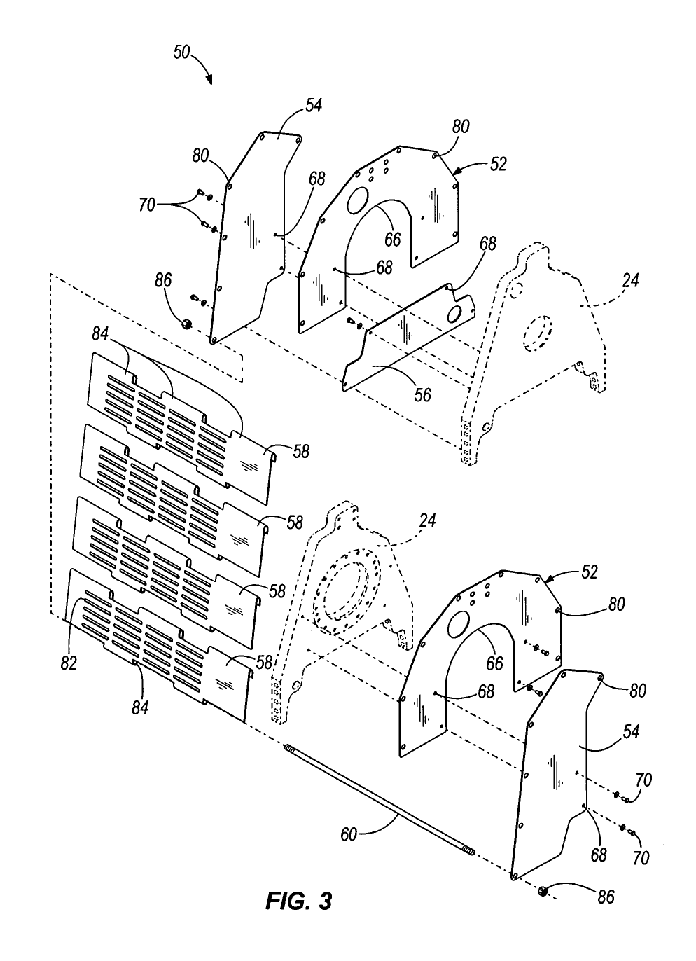

FIGS. 3 illustrates a winch drum guard assembly 50 adapted to be mounted to the winch 20 to cover an exposed portion of the winch 20 (i.e., the portion of the drum 26 not covered by the winch frame 22 or otherwise blocked from user access during ordinary operation of the winch 20) and the automatic band brake 30. The drum guard assembly 50 includes end panels 52, brake panels 54, a lower end panel 56, guard panels 58, and support rods 60. The illustrated panels are preferably made from a thin, rigid sheet metal, but could conceivably be made from hard plastic or other stiff, preferably shatter-resistant material. Alternative embodiments of the present invention may require panels that are a different shape to accommodate differences in winch size, band brake size and orientation, and/or prime mover size and orientation.

Each end panel 52 defines a U-shaped cut-out 66 to accommodate the prime mover 28. The end panels 52 and the brake panels 54 include mounting holes 68 that align with each other so that common fasteners 70 may be used to mount both panels to the drum supports 24. The lower end panel 56 includes mounting holes 68 to facilitate mounting to the drum supports 24. The lower end panel 56 covers the ends of the rotating drum 26 below the drum supports 24.

The outer edge of the brake panels 54 extend beyond the outer edge of the end panels 52. The outer edges of the end panels 52 and brake panels 54 both have flat portions. The flat portions of the end panels 52 are all about the same length as the guard panels 58. The brake panels 54, however, include long, tall flat portions that are about the length of three guard panels 58, and a pair of flat portions that are each about the length of a single guard panel 58 and are in a tented formation. The outer perimeters of the end panels 52 and brake panels 54 also include a plurality of rod guides 80, which are apertures adapted to support the support rods 60. The rod guides 80 are equally spaced about the perimeter of the end panels 52 and brake panels 54 at intervals corresponding to the length of the guard panels 58.

The guard panels 58 are generally rectangular in shape and include a plurality of slots 82 that allow a winch operator to view the flexible tension member 40 as it is wound onto the drum 26 during operation. The guard panels 58 include hinge journals 84, which in the illustrated embodiment are formed by bending the top and bottom portions or ears of the guard panels 58 over. The hinge journals 84 are essentially slots which are closed and curved at one end and open at the opposite end. The curved end describes a 180° arc, wherein the open end is about as wide as the diameter of the support rods 60. One edge of the guard panels 58 has three hinge journals 84 and the other end has two hinge journals 84. The support rods 60 are long cylindrical metal rods, threaded at one or both ends. In alternative embodiments, the support rods 60 may be made of plastic or another suitably hard and rigid material. The support rods 60 are sized to snugly fit within the hinge journals 84 and the rod guides 80.

During assembly, the two-hinge-journal 84 edge of each guard panel 58 is placed adjacent the complementary three-hinge-journal 84 edge of the adjacent guard panel 58 so that the hinge journals 84 combine to form a substantially continuous journal for a support rod 60 along the entire edge of the adjacent guard panels 58. This continuous journal is then aligned with a pair of rod guides 80 in the end panels 52 or brake panels 54, and a support rod 60 is extended through the rod guides 80 and hinge journals 84 to secure the adjacent guard panels 58 to each other and to the end panels 52 or brake panels 58. Nuts 86 are then threaded onto the ends of the support rods 60 to retain them in an operating position. The rod guides 80 are spaced such that the support rods 60 are in the curved ends of the respective hinge journals 84 and the guard panels 58 are supported without much slop.

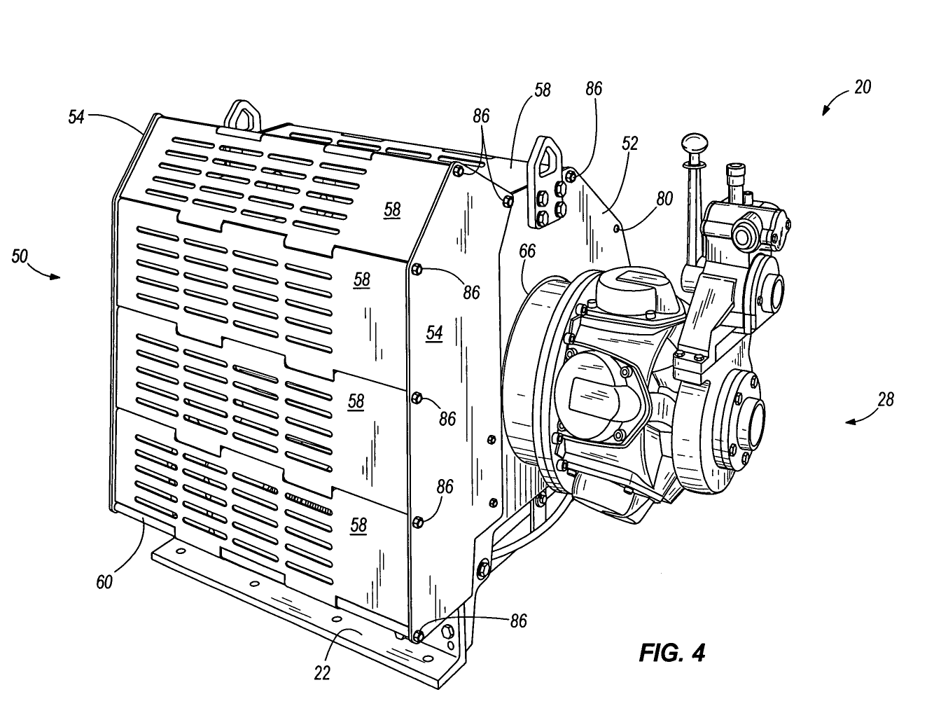

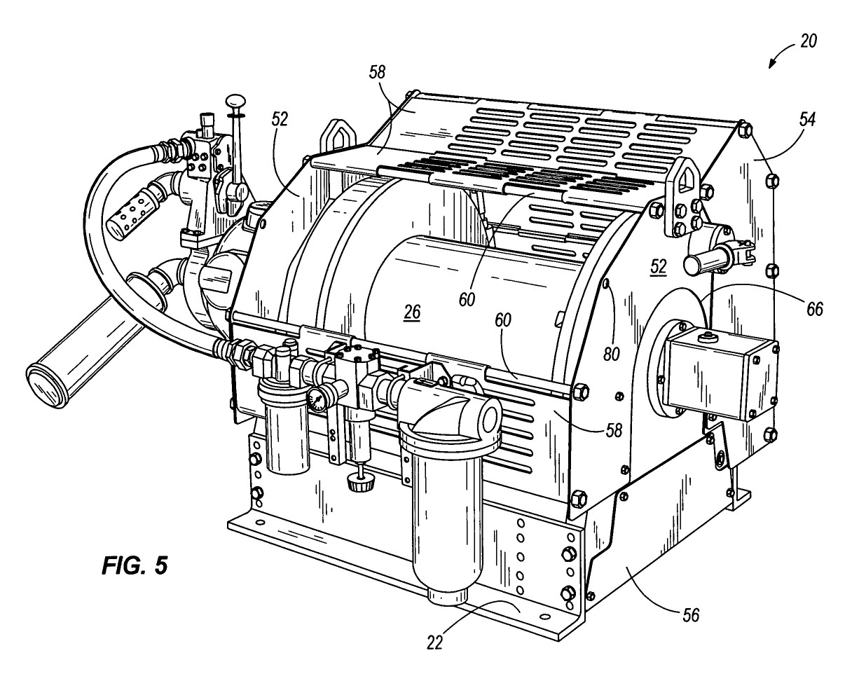

When assembled, as illustrated in FIGS. 4 and 5, the drum guard assembly 50 covers the automatic band brake 30 and the entire exposed portion of the drum 26 except for a window through which the flexible tension 40 member extends. The brake panels 54 arrange the guard panels 58 in a relatively tall, vertical profile to provide clearance around the automatic band brake 30. The brake panel 54 also provides an additional guard panel 58 to cover the bottom of the brake cylinder 34, which is in front of the frame 22. The window is formed by the removal of one or more guard panels 58 corresponding to the takeoff angle α of the flexible tension member 40. Any guard panel 58 may be removed by removing one of the two support rods 60 that supports it. Once one of the support rod 60 is removed, the guard panel 58 may slide off of the other support rod 60 through the open end of the hinge journal 84. If the takeoff angle α changes (e.g., due to the winch 10 being moved or used in a different application), one or more other guard panels 58 may be removed to form a new window for the new takeoff angle α, and those guard panels 58 can be used to cover the previous window. In most cases (unless the takeoff angle α is at one end of the range of takeoff angles), the window will be defined between two guard panels 58.

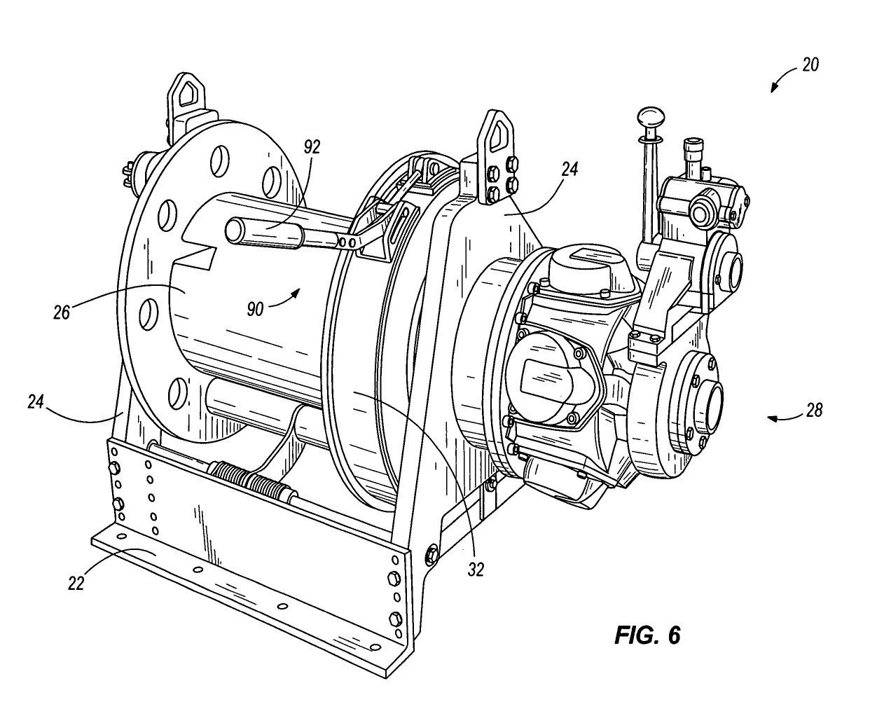

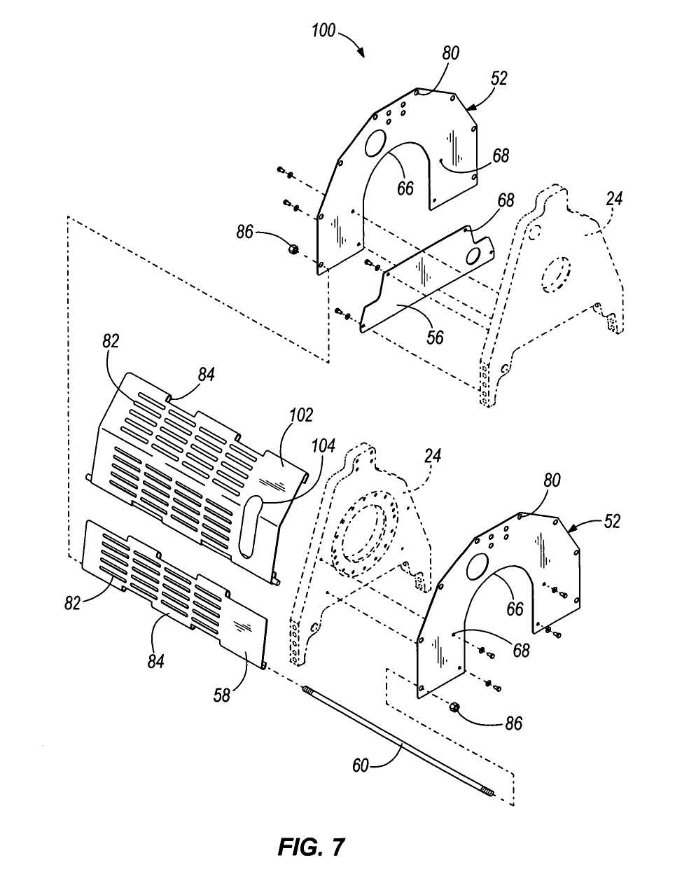

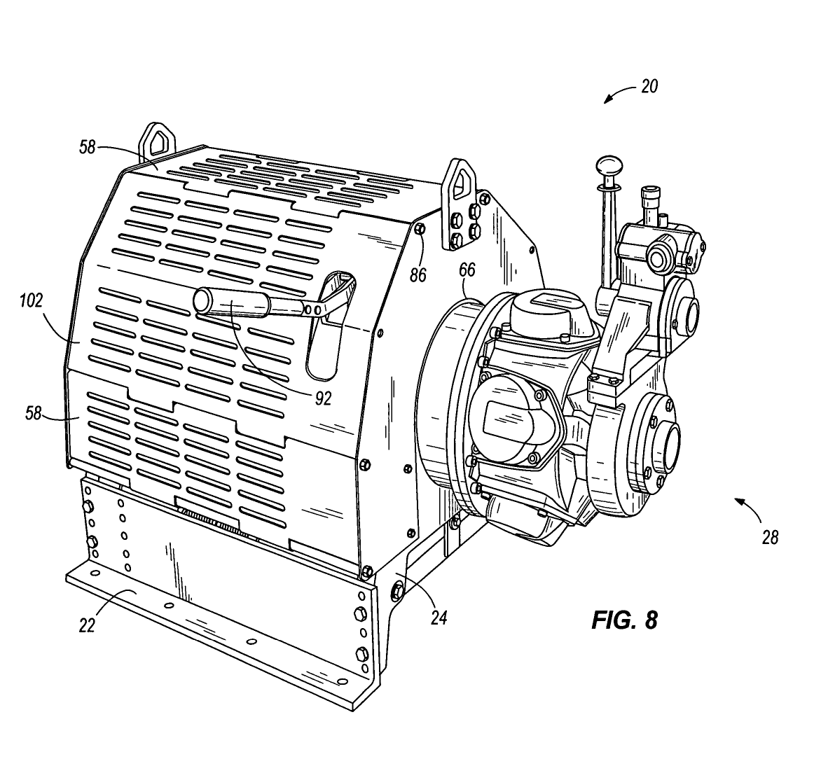

FIG. 6 illustrates a winch having a manual band brake 90 in place of the automatic band brake 30 illustrated in FIG. 1. The manual band brake 90 includes a handle 92 or lever that may be actuated by an operator of the winch 20. Actuation of the handle 92 causes the band 32 to tighten around a portion of the drum 26 to resist rotation of the drum 26. The drum guard assembly 100 for this type of winch is illustrated in FIGS. 7-9, and is different from the drum guard assembly 50 described above in two ways. First, because there is no bulky actuation cylinder 34 associated with the braking mechanism, the drum guard assembly 100 may more closely follow the contours of the drum 26. Consequently, the guard panels 58 are supported by the end panels 52 without the use of the brake panels 54. Also, the space over the manual brake handle 92 is covered by a unitary guard panel 102 that is the length of two ordinary guard panels 58. The unitary guard panel 102 includes a slot 104 through which the manual brake handle 92 extends, and which accommodates the full range of motion of the handle 92. The range of motion of the manual brake handle 92 would be limited by a support rod 60 if two individual guard panels 58 were used in place of the single unitary guard panel 102. Other embodiments of the current invention can be applied to winches lacking a band brake altogether. This scenario would require a guard assembly identical to the guard assembly 50 except that the unitary guard panel 102 could be replaced by two guard panels 58.

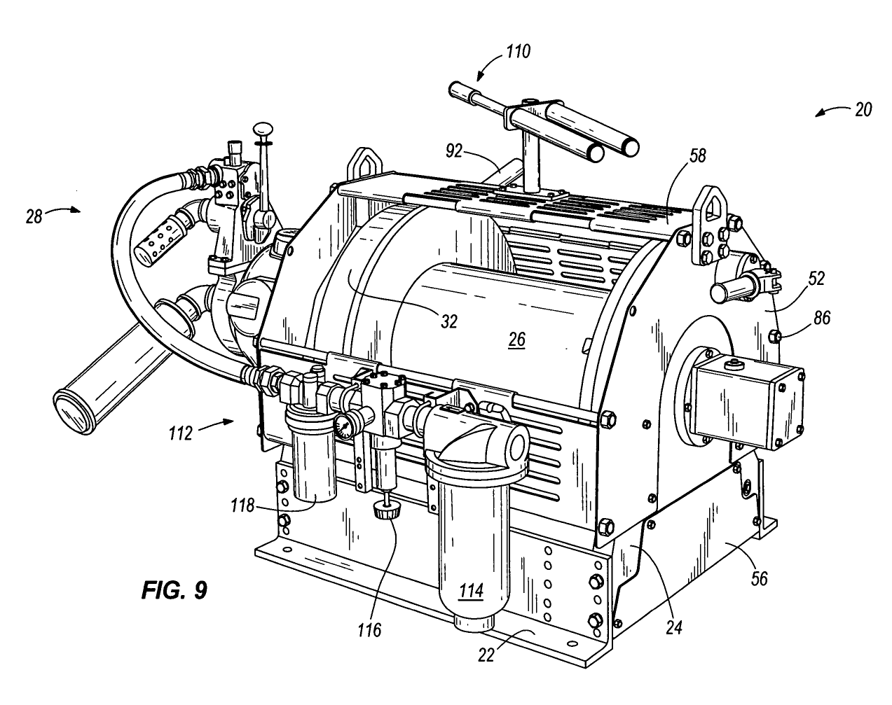

FIG. 9, in addition to showing a rear perspective view of the winch of FIG. 6, illustrates a cable guide apparatus 110 and an air preparation package 112 that may be used with either guard assembly 50, 100, and regardless of whether the winch 20 includes an automatic or manual brake assembly 30, 90. The guide apparatus 110 is mounted to one of the guard panels 58 and can be mounted in any of the slots 82 located on any of the guard panels 58 to assist in level winding of the flexible tension member 40 onto the drum 26. The air preparation package 112 includes a filter 114, regulator 116 and lubricator 118 that condition the compressed air that drives the prime mover 28. The guide apparatus 110 and air preparation package 112 may be used in combination or separately depending on the needs of a specific application.

Various features and advantages of the invention are set forth in the following claims.

1. A winch comprising:
a frame;
a drum rotatably supported by the frame and having an exposed portion not covered by the frame;
a flexible tension member interconnected with the drum and wound onto and off of the drum in response to drum rotation in respective winding and unwinding directions, the flexible tension member defining a takeoff angle with respect to the drum; and
a drum guard including a plurality of guard panels supported by the frame to cover substantially the entire exposed portion of the drum except for a window defined between two panels and corresponding to the takeoff angle of the flexible tension member;
wherein the guard panels are movable to move the window to accommodate substantially any takeoff angle within the exposed portion.

2. The winch of claim 1, wherein each guard panel is removable from the frame upon the removal of a single fastener associated with that guard panel.

3. The winch of claim 1, wherein the plurality of guard panels are hingedly coupled to each other.

4. The winch of claim 1, wherein each guard panel includes at least one hinge journal, wherein the hinge journal of adjacent guard panels are aligned, and wherein an elongated hinge rod extends through the aligned hinge journals.

5. The winch of claim 4, wherein each hinge rod is fastened to the frame.

6. The winch of claim 1, further comprising a modular flexible tension member guide movably coupled to the drum guard, wherein the flexible tension member extends through the guide and wherein movement of the guide facilitates evenly winding the flexible tension member onto the drum.

7. The winch of claim 1, further comprising a brake for selectively resisting rotation of the drum; and means for actuating the brake; wherein at least a portion of the means for actuating is covered by the drum guard.

8. The winch of claim 8, wherein the means for actuating includes a pressurized cylinder that is substantially completely covered by the drum guard.

9. The winch of claim 8, wherein the means for actuating includes a manual lever, and wherein one of the plurality of guard panels includes a slot through which the manual lever extends to enable an operator to actuate the manual lever.

10. The winch of claim 1, wherein the prime mover operates under the influence of compressed air, the winch further comprising an air preparation system coupled to the drum guard and operable to condition compressed air for use within the prime mover.

11-19. (canceled)
